(19) United States
(12) Patent Application Publication
(10) Pub. No.: US 2005/0013129 A1
(43) Pub. Date: Jan. 20, 2005

(54) Cup pad with a radiation means

(76) Inventor: Mei-Ning Zhang, Ningbo City (CN)

Correspondence Address: RABIN & BERDO, P.C., Suite 500, 1101 14 Street, N.W., Washington, DC, 20005, US

(21) Appl. No.: 10/621,393

(22) Filed: Jul. 18, 2003

(51) Int. Cl. F21V 33/00

(52) U.S. Cl. 362/96; 362/800

(57) ABSTRACT

The present invention is related to a cup pad with a radiation means, comprising a body with a hole base, a pervious containing room, a radiation unit and a switch. Via a PCB of the radiation unit embedded in the pervious containing room, a switching element of the switch is set in a back cover of the pervious containing room and elongates in a bottom portion of the body. While the surface of the body being put a cup, a weight of the cup is able to drive the switching element; on the other hand, both waves generated by receiving or dialing of a mobile phone are received by the receiver to drive the circuits of the radiation unit, and thus the LEDs controlled by IC chips illuminate variable lights.

### BACKGROUND OF THE INVENTION

1. Field of the Invention

The present invention is related to a cup pad with a radiation means, especially to the cup pad automatically radiating with variable colors while a cup being put thereon for improving effects.

2. Description of the Prior Art

The original purpose for cup pad is to cushion the effect of heat from hot water for the table surface being damaged, and another purpose is to keep it in a clean stage. As the cup pad being used for a while, more functions as decoration, artistry and interest were added, and the functions can be approached by the structure, appearance and colors of the cup pad. Presently, there are many types of cup pads in the market for a while, hence the attraction is gradually lost, and a cup pad connecting a radiation means is then developed. In prior arts, to simply drill a hole on a body of the cup pad and install a light-source means with controlling device therein for the body being radiated itself, although the function of interest is done, manual operation is another inconvenience, further that, the light is not variable; another advanced design is a radiation means assembled by a radiation piece driven by a controller and a pervious member being installed in a containing room of the body. The controller drives the radiating piece to have light going through the pervious member with some special patterns, and therefore the patterns are appeared on a surface of the cup pad, but unfortunately, it is still manual, and the complicate structure costs high, so the improvement for the prior art is exist as well.

### SUMMARY OF THE INVENTION

A cup pad with a radiation means, comprising a body, a pervious containing room, a radiation unit and a switch. At least one hole base being on a suitable position of the body is capable of installing the pervious containing room in the body, and a display of the pervious containing room is placed on a surface of the body. The radiation unit with a PCB (printed circuit board) of a receiver is embedded in the pervious containing room, plural LEDs controlled by IC chips are on a surface of the radiation unit, another bottom surface has circuits and a power. Thus, the surface with LEDs is corresponding to the display of the pervious containing room; the bottom surface with circuits and the power is relative to a back cover of the pervious containing room, that is, on a bottom surface of the body. The switch of the radiation unit is comparative to the circuits, and a switching element of the switch is laid on the bottom surface of the body via the back cover of the pervious containing room. While the surface of the body being put a cup, a weight of the cup is able to drive the switching element; on the other hand, both electric waves generated by receiving or dialing of a mobile phone are received by the receiver to drive the circuits of the radiation unit, and thus the LEDs controlled by IC chips illuminate variable lights. The lights go through the display of the pervious containing room, and continuously the lights are appeared on the surface of the body. The main objective of the present invention is that the body generates multiple flash lights during the process of placing on and taking away the cup and the waves of receiving and dialing from the mobile phone. Because of its automatic functions and variable flash lights, the interests are highly promoted.

### BRIEF DESCRIPTION OF THE DRAWINGS

FIG. 1 is an explored 3-D view of a first preferred embodiment of the present invention.

FIG. 2 is a top view of a surface of a PCB of the first preferred embodiment of the present invention.

FIG. 3 is a top view of a bottom surface of the PCB of the first preferred embodiment of the present invention.

FIG. 4 is a sectional view of the first preferred embodiment of the present invention.

FIG. 5 is a sketch of an application of the first preferred embodiment of the present invention.

### DETAILED DESCRIPTION OF THE INVENTION

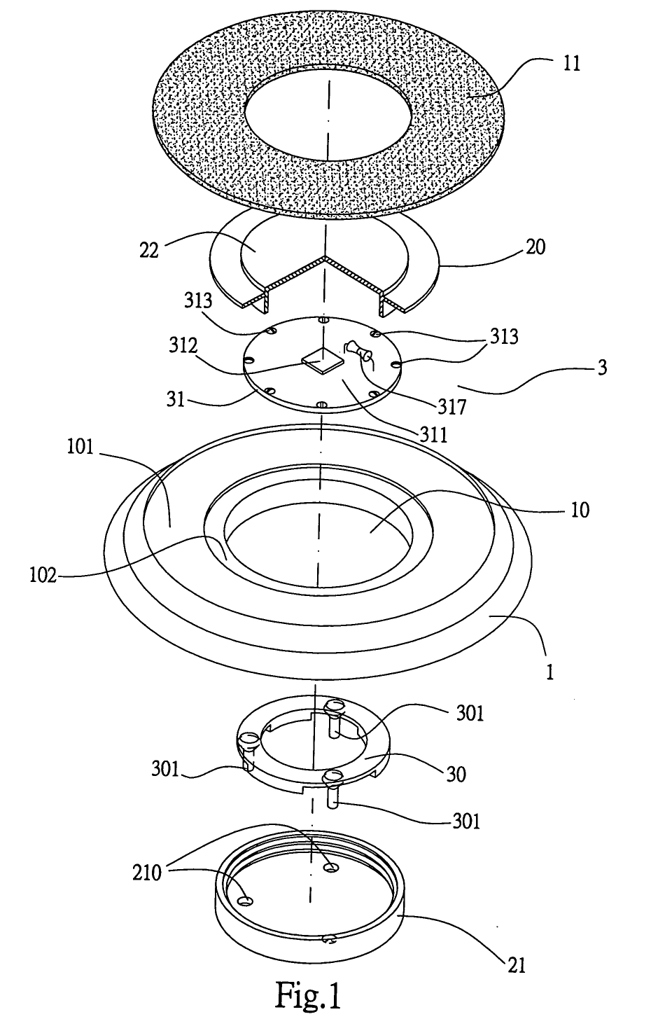

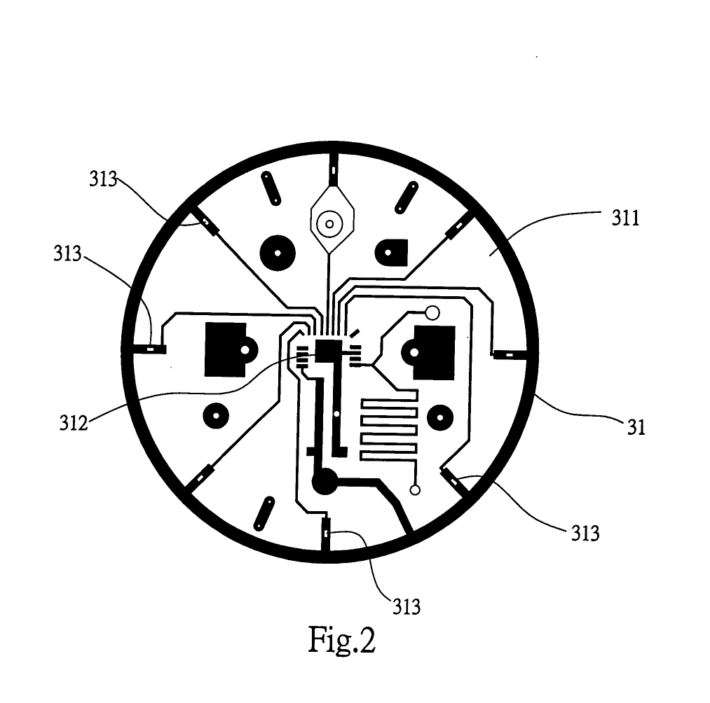

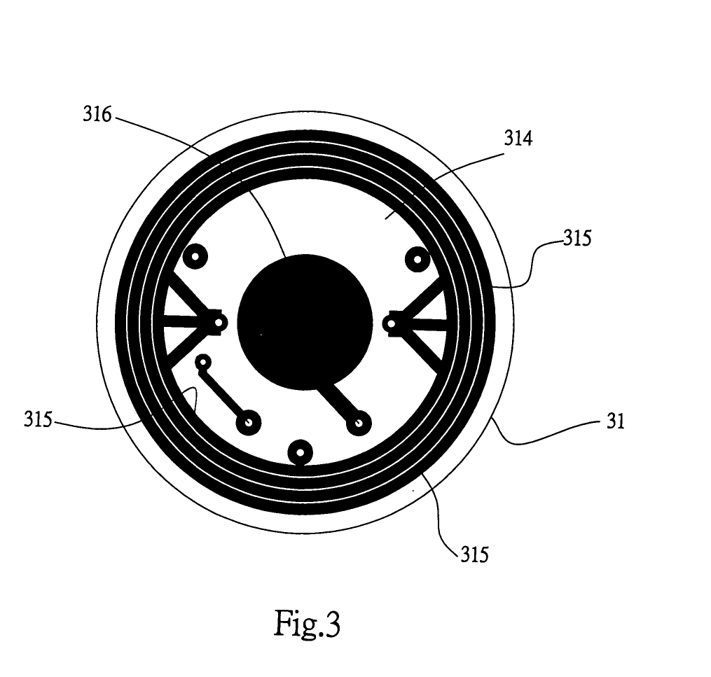

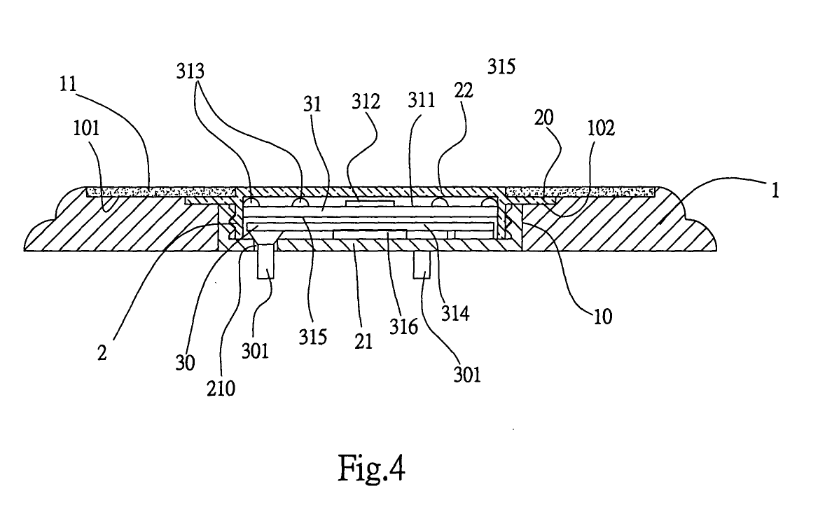

Please refer to FIG. 1, which is an explored 3-D view of a first preferred embodiment of the present invention. The present invention comprises a body 1, a pervious containing room 2, a radiation unit 3 and a switch 30, wherein a suitable position of the body 1 is set a hole base 10, the hole base 10 is shaped as multiple layers on a surface of the body 1, an outer layer 101 is laid on a gasket 11 of the surface of the body 1, an inner layer 102 is set on the pervious containing room 2 for the room 2 stably positioning on the surface of the body 1. Besides, the pervious containing room 2 is a transparent containing room, which includes a screwed back cover 21, a cooperation of a projecting ring 20 on a top edge of the room 2 and the inner layer 102 on the surface of the body 1 is capable of keeping an upper display 22 of the room 2 and the gasket 11 of the body 1 on a same plane, shown as FIG. 4, that is, to make the cup pad being horizontal. The radiation unit 3 is embedded on the room 2 and includes the switch 30 and a PCB 31 with a receiver 317. As shown in FIG. 2, a plurality of LEDs 313 driven by an IC chip 312 on a surface 311; as shown in FIG. 3, another bottom surface 314 has circuits 315 and a power 316. The switch 30 of the radiation unit 3 is fit in the cover 21 of the room 2, and thus using a switching element 301 of the switch 30 to cooperate with the hole 210 of the back cover 21 for the switching element 301 elongating to a bottom portion of the back cover 21, continuously, the PCB 31 of the radiation unit 3 is embedded in the pervious containing room 2 of the surface of the body 1, therefore the surface 311 is corresponding to the display 22 of the room 22. As shown in FIG. 4, after fastening the back cover 21 by screwing, the switching element 301 of the switch 30 is thus comparative to the circuits 315 of the bottom surface 314 of the PCB 31, the switching element 301 elongates to the bottom surface of the body 1 simultaneously.

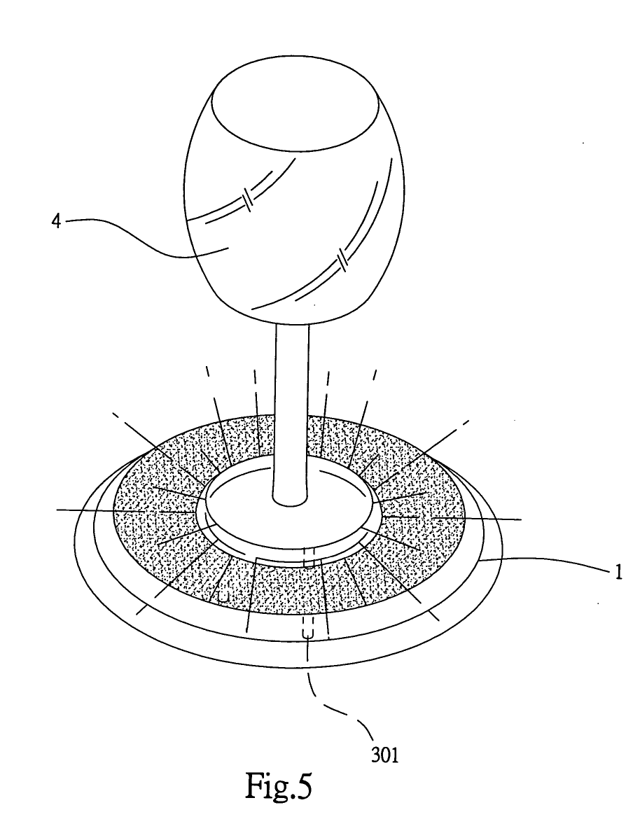

As shown in FIG. 5, while in application, a cup 4 is put on the body 1, the weight of the cup 4 drives the switching element 301 elongating in the bottom surface of the body 1. Due to the switching element 301 being made of soft conductive rubber and partially adhered on the back cover 21, the pressing force of the weight is to let the switching element 301 moving up to touch the circuits 315 of the bottom surface 314 of the PCB 31, the power 316 then drives the IC chip 312 on the surface 311 of the PCB 31 to control the LEDs 313 emitting. The display 22 of the room 2 comparative to the surface 311 then shows flash lights; on the contrary, while the cup 4 being taken away from the body 1, the pressing force from the weight of the cup 4 is gone, the switching element 301 recovers by its own flexibility and elongates to the original position in the bottom surface of the body 1, and the power 316 is cut off, so the LEDs 313, the IC chip 312 stop working. Following the cup 4 being put on and taken away, the surface of the body 1 automatically emits flash lights; on the other hand, the receiver 317 drives the power 316 to let the IC chip 312 on the surface 311 of the PCB 31 control a plurality of LEDs 313 emitting for appearing an incoming phone. Obviously, the features of the convenience and the interest of the present invention are advanced than the prior arts.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

1. A cup pad with a radiation means comprising:
a body having a hole base on a suitable position thereof;
a pervious containing room having a transparent containing room with a back cover fastened by screwing;
a radiation unit having a switch and a PCB, which one surface having a plurality of LEDs controlled by an IC chip, another bottom surface having circuits and a power device, wherein the switch having a switching element.

2. The cup pad with the radiation means as cited in claim 1, wherein the hole base is shaped as multiple layers on a surface of the body, and a gasket is set on the surface.

3. The cup pad with the radiation means as cited in claim 2, wherein a cooperation of a projecting ring on a top edge of the room and an inner layer on the surface of the body is capable of keeping an upper display of the pervious containing room and the gasket of the body on a same plane.

4. The cup pad with the radiation means as cited in claim 1, wherein the PCB of the radiation unit is embedded in the containing room, and a surface of the radiation unit is corresponding to a display of the pervious containing room.

5. The cup pad with the radiation means as cited in claim 1, wherein the switch of the radiation unit is fit in the cover of the room, and thus using the switching element of the switch to cooperate with a hole of the back cover for the switching element elongating to a bottom portion of the back cover.

6. The cup pad with the radiation means as cited in claim 5, wherein the switching element of the switch is corresponding to the circuits of the bottom surface of the PCB in the pervious containing room after the back cover fastening with the pervious containing room by screwing.

7. The cup pad with the radiation means as cited in claim 1, wherein the switch is made of soft conductive rubber and partially adhered on the back cover for the switching element of the switch having flexibility.

8. The cup pad with the radiation means as cited in claim 1, wherein the switch can be driven by a receiver to let the IC chip on the surface of the PCB control plural LEDs emitting for showing an incoming telephone.
